(19) United States
(12) Patent Application Publication
(10) Pub. No.: US 2021/0007375 A1
(43) Pub. Date: Jan. 14, 2021

(54) FOOD CONTAINING HEAT-TREATED VEGETABLE, PROCESS OF PRODUCING THE SAME, AND METHOD FOR REDUCING UNPLEASANT TASTE OF VEGETABLE

(71) Applicant: MIZKAN HOLDINGS CO., LTD., Aichi (JP)

(72) Inventor: Anna Fujiwara, Aichi (JP)

(73) Assignee: MIZKAN HOLDINGS CO., LTD., Aichi (JP)

(21) Appl. No.: 16/787,784

(22) Filed: Feb. 11, 2020

(30) Foreign Application Priority Data
Jul. 11, 2019 (JP) 2019-129276

(51) Int. Cl. A23L 5/10; A23L 19/00; A23L 29/00

(52) U.S. Cl. CPC A23L 5/12; A23L 29/055; A23L 19/00

(57) ABSTRACT

A food product includes a heat-treated vegetable. A content of 3,4-dimethylthiophene (x) in the food product ranges from 0.00035 mg/kg to 3 mg/kg. A content of 2,4-dimethylthiophene (y) in the food product ranges from 0.00015 mg/kg to 3 mg/kg. A content of furfural (z) in the food product ranges from 0.1 mg/kg to 10 mg/kg.

### TECHNICAL FIELD

One or more embodiments of the present invention relate to a food containing heat-treated vegetable and a process of producing the same, as well as a method for reducing unpleasant taste of vegetable.

### BACKGROUND

Consumers want to eat vegetables actively because of their unique rich taste and high nutritional values. However, consumers tend not prefer seasoned foods with enhanced vegetable contents, due to their unique raw smell and unpleasant taste.

Various researchs and reports have been made regarding the reduction of the unpleasant taste of vegetables. For example, Patent Document 1 discloses an onion extract prepared via heat-cooking under specific conditions, which extract can easily provide foods with strong sweetness and rich taste of heated onion. Patent Document 2 discloses a spice composition which can provide spicy vegetable's unique flavor and mellow cooked feel.

Although these techniques can be used for adding heat-cooked feel to vegetables, neither technique is sufficient to reduce the unpleasant taste of vegetables.

### LIST OF CITATIONS

### Patent Literature

[Patent Literature 1] JP2010-142147A

[Patent Literature 2] JP2003-000181A

### SUMMARY

One or more embodiments of the present invention provide a food containing heat-treated vegetable that can reduce the unpleasant taste of vegetables while adding cooked feel thereto, and also to provide a process of producing the same.

The present inventors conducted extensive study, and have finally found that heat-treated vegetable containing 3,4-dimethylthiophene, 2,4-dimethylthiophene, and furfural at specific concentrations can not only add cooked feel to vegetables but also reduce the unpleasant taste of the vegetable, enabling the production of a food containing heat-treated vegetable which is much more suited to consumer preference.

Incorporation of 3,4-dimethylthiophene, 2,4-dimethylthiophene, and furfural (specific ingredients) into heat-treated vegetable can be adjusted by adding these specific ingredients as pure substances, or adding materials containing these specific ingredients, to vegetable before, during, or after heating the vegetable. Alternatively, it can also be achieved by adjusting the contents of 3,4-dimethylthiophene, 2,4-dimethylthiophene, and furfural each to within a predetermined range via heating when preparing the heat-treated vegetable.

One or more embodiments of the present invention relate to the following aspects:

### [Aspect 1]

A food containing heat-treated vegetable, comprising.
(a) 3,4-dimethylthiophene (x) in a content of from 0.00035 mg/kg to 3 mg/kg;
(b) 2,4-dimethylthiophene (y) in a content of from 0.00015 mg/kg to 3 mg/kg; and
(c) furfural (z) in a content of from 0.1 mg/kg to 10 mg/kg.

### [Aspect 2]

A food according to aspect 1, which satisfies the following formula:

10≥(x+y)/z≥0.0005 [Formula 1]

### [Aspect 3]

A food according to aspect 1 or 2, wherein the vegetable is Allium.

### [Aspect 4]

A food according to aspect 3, wherein Allium is one or more selected from onion, Welsh onion (negi), leek, and garlic.

### [Aspect 5]

A food according to any one of aspects 1 to 4, wherein the content of the heat-treated vegetable is 1.5 mass % or more.

### [Aspect 6]

A process for producing a food according to any one of aspects 1 to 5, comprising:

(1) heating vegetable with stirring at a temperature of from 70° C. to 120° C., until the mass of the vegetable is reduced to an amount of from 30 mass % to 70 mass % with respect to the mass of the vegetable before heating; and
(2) adding, to the heated vegetable from step (1), oil in an amount of from 1 mass % to 10 mass % with respect to the mass of the vegetable before the heating, and further heating the vegetable with stirring at a temperature of from 70° C. to 120° C.

### [Aspect 7]

A process according to aspect 6, wherein step (1) comprises depressurization treatment and/or ventilation treatment.

### [Aspect 8]

A process according to aspect 6 or 7, further comprising, before or during step (1), adding, to the vegetable, sodium chloride in an amount of from 1% to 10% with respect to the mass of the vegetable before the heating.

### [Aspect 9]

A process according to any one of aspects 6 to 8, wherein the heating in step (2) is carried out until the resultant heat-treated vegetable satisfies requirements (a) to (c) recited in aspect 1.

### [Aspect 10]

A process according to any one of aspects 6 to 9, further comprising, before, during, or after the heating in step (1) and/or step (2), adding to the vegetable one or more selected from 3,4-dimethylthiophene, 2,4-dimethylthiophene, and furfural.

### [Aspect 11]

A method for reducing unpleasant taste of vegetable, comprising:

adjusting the contents of a food containing heat-treated vegetable so as to comprise:

(a) 3,4-dimethylthiophene (x) in a content of from 0.00035 mg/kg to 3 mg/kg;
(b) 2,4-dimethylthiophene (y) in a content of from 0.00015 mg/kg to 3 mg/kg; and
(c) furfural (z) in a content of from 0.1 mg/kg to 10 mg/kg.

One or more embodiments of the present invention enable the production of a food containing heat-treated vegetable that only has cooked feel of vegetables but also exhibits reduced unpleasant taste of vegetables, and is therefore much more suited to consumer preference, by simply adjusting the contents of 3,4-dimethylthiophene, 2,4-dimethylthiophene, and furfural in heat-treated vegetable to within specific ranges.

The term “cooked feel” herein means good tastes of vegetables produced by heating vegetables, including natural sweetness and flavors resulting from heating. The term “unpleasant taste” herein collectively means various unpleasant flavors scented when eating vegetables, such as raw taste/odor or pungent taste/odor of vegetables.

### DETAILED DESCRIPTION OF EMBODIMENTS

One or more embodiments of the invention will now be described in greater details by reference to specific embodiments thereof. However, it is to be understood that the invention should not in any way be restricted to the following embodiments, and various modifications thereof may be implemented without departing from the spirit of the present invention.

In the following description, 3,4-dimethylthiophene, 2,4-dimethylthiophene, and furfural may collectively be referred to as “specific ingredients.”

### [Food Containing Heat-Treated Vegetable]

A first aspect according to one or more embodiments of the present invention relates to a food containing heat-treated vegetable (hereinafter also referred to as “the food containing heat-treated vegetable according to one or more embodiments of the present invention” or simply as “the food according to one or more embodiments of the present invention”) containing 3,4-dimethylthiophene, 2,4-dimethylthiophene, and furfural (specific ingredients) each in a predetermined amount. The food containing heat-treated vegetable according to one or more embodiments of the present invention may either consist of heat-treated vegetable or contain one or more other materials or ingredients in addition to the heat-treated vegetable.

### *Heat-Treated Vegetable:

The food according to one or more embodiments of the present invention contains heat-treated product of vegetable. The heating time for preparing the heat-treated vegetable should not be limited. In addition to the specific ingredients resulting from the heating, the heat-treated vegetable may preferably include various other ingredients, since they may serve to improve the cooked feel and reduce the unpleasant taste. Vegetable may preferably be heated with equipment having a capacity sufficient to uniformly heat vegetable, so that uneven heating for each part is less likely to occur. Details of the heating treatment will be described later.

### *Vegetables:

Vegetables to be heated according to one or more embodiments of the present invention include, although not particularly limited to: Japanese radish, carrot, burdock, rutabaga, beet (for example, beetroot: a variety of beet improved for making its root edible), parsnip, turnip, sweet potato, cassava, yacon, taro, satoimo (variety of taro), konjac potato, lotus root, potato, purple potato, yellow potato, quill, shallot, garlic, Japanese leek (rakkyo), lily bulb (yurine), Asian fawnlily (katakuri), kale, yam, Japanese yam (yamanoimo), Chinese yam (nagaimo), onion, asparagus, Japanese spikenard (udo), cabbage, lettuce, spinach, Chinese cabbage (hakusai), oilseed rape, Japanese mustard spinach (komatsuna), bok choy, Chinese chive, Welsh onion (negi), nozawana, leek, sweet coltsfoot (fuki), potherb mustard (mizuna), tomato, eggplant, pumpkin, bell pepper, cucumber, ginger, cauliflower, broccoli, bitter melon (nigauri), okra, artichoke, zucchini, suger beet, ginger, shiso (Japanese basil), and paprika. These vegetables may be used either singly or in combination of any two or more. The vegetables to be used are not limited to fresh vegetables; processed products such as frozen vegetables, water-reconstituted products of dried vegetables, salted vegetables, etc., can also preferably be used, as long as they contain moisture equivalent to fresh products.

Vegetables whose unpleasant taste can preferably be reduced according to one or more embodiments of the present invention include vegetables belonging to the genus Allium. Examples of vegetables belonging to the genus Allium include onion, Welsh onion (negi), leek, and garlic.

Vegetables can be used not only in a solid form such as whole or diced, but also in a processed form such as pulverized particles, puree, paste, or the like.

### *Contents of Specific Ingredients:

The food containing heat-treated vegetable according to one or more embodiments of the present invention contains 3,4-dimethylthiophene, 2,4-dimethylthiophene, and furfural (specific ingredients) each in a predetermined amount.

The lower limit of the content of 3,4-dimethylthiophene (x) in the food according to one or more embodiments of the present invention may be 0.00035 mg/kg or more, preferably 0.0004 mg/kg or more. If the content of 3,4-dimethylthiophene (x) is below the lower limit, vegetable flavor may not be fully felt.

The upper limit of the content of 3,4-dimethylthiophene (x) in the food according to one or more embodiments of the present invention may be 3 mg/kg or less, preferably 1 mg/L or less. If the content of 3,4-dimethylthiophene (x) exceeds the upper limit, pungent odor from the vegetable may be so strong as to cause discomfort.

The lower limit of the content of 2,4-dimethylthiophene (y) in the food according to one or more embodiments of the present invention may be 0.00015 mg/kg or more, preferably 0.0002 mg/kg or more. If the content of 2,4-dimethylthiophene (y) is below the lower limit, vegetable taste may not be fully felt.

The upper limit of the content of 2,4-dimethylthiophene (y) in the food according to one or more embodiments of the present invention may be 3 mg/kg or less, preferably 1 mg/kg or less. If the content of 2,4-dimethylthiophene (y) exceeds the upper limit, pungent odor from the vegetable may be felt strongly.

The lower limit of the content of furfural (z) in the food according to one or more embodiments of the present invention may be 0.1 mg/kg or more, preferably 0.2 mg/kg or more. If the content of furfural (z) is below the lower limit, desired flavors may not be added sufficiently to reinforce cooked feel.

The upper limit of the content of furfural (z) in the food according to one or more embodiments of the present invention may be 10 mg/kg or less, preferably 5 mg/kg or less, more preferably 1 mg/kg or less. If the content of furfural (z) exceeds the upper limit, the odor of furfural may be felt so strongly as to cause unnatural sweetness.

The total ratio of the content of 3,4-dimethylthiophene (x) and the content of 2,4-dimethylthiophene (y) to the content of furfural (z) in the food according to one or more embodiments of the present invention, i.e., the ratio (x+y)/z, may preferably have a lower limit of 0.0005 or higher, more preferably 0.001 or higher. If the value of (x+y)/z is below the lower limit, vegetable flavor may not be fully felt.

In one or more embodiments, the upper limit of the ratio (x+y)/z may be 10 or lower, preferably 7 or lower, more preferably 3 or lower. If the ratio (x+y)/z exceeds the upper limit, good cooked feel may not be sufficiently added to the heat-treated vegetable, or the pungent taste of the vegetable may not be sufficiently suppressed.

According to one or more embodiments of the present invention, the contents of 3,4-dimethylthiophene, 2,4-dimethylthiophene, and furfural in a food containing heat-treated vegetable can be measured using gas chromatography/mass spectrometry (GC/MS).

The food according to one or more embodiments of the present invention is characterized by containing 3,4-dimethylthiophene, 2,4-dimethylthiophene, and furfural (specific ingredients) each in a predetermined amount, whereby not only cooked feel is provided, but also unpleasant taste is reduced.

The methods for incorporating 3,4-dimethylthiophene, 2,4-dimethylthiophene, and furfural (specific ingredients) into heat-treated vegetable include, although not particularly limited to: a method including adding these specific ingredients as pure substances, or adding materials containing these specific ingredients, to vegetable before, during, or after heating the vegetable; and a method including adjusting the contents of 3,4-dimethylthiophene, 2,4-dimethylthiophene, and furfural each to within its desired concentration range via heating when preparing the heat-treated vegetable. In one or more embodiments, the latter method is preferred, since the resultant heat-treated vegetable also includes other aroma ingredients which may involved in reducing the unpleasant taste of vegetable.

### *Other Materials and Ingredients:

The food containing heat-treated vegetable according to one or more embodiments of the present invention may also contain any other materials or ingredients in addition to vegetable and the specific ingredients (3,4-dimethylthiophene, 2,4-dimethylthiophene, and furfural). If the food according to one or more embodiments of the present invention contains any materials or ingredients that are not derived from the heat-treated vegetable, examples of such materials or ingredients include, although not particularly limited to: plant-derived ingredients such as spices and herbs, taste/flavoring ingredients such as sugars, high-intensity sweeteners, amino acid seasonings, nucleic acid seasonings, organic acid seasonings, flavor ingredients, umami seasonings, alcoholic beverages, flavor oils, flavors, and spice extracts; additives such as viscosity modifiers, stabilizers, pH adjusters, colorants; salts such as sodium chloride; oil and water. These materials and ingredients may be used either singly or in combination of any two or more at any ratios. The contents of these materials and ingredients are not particularly limited, and can be determined as appropriate depending on, e.g., usages.

### *Embodiments of Foods:

Embodiments of the food containing heat-treated vegetable according to one or more embodiments of the present invention generally include, although not limited to: foods based mainly on the heat-treated vegetable (hereinafter referred to as foods according to the first embodiment); and foods containing the heat-treated vegetable as one of a plurality of components (hereinafter referred to as foods according to the second embodiment). Examples of the latter embodiment include foods that can fully utilize vegetable flavor, such as pasta sauce, dressing, and steak sauce.

When the food according to one or more embodiments of the present invention is a food based mainly on the heat-treated vegetable (i.e., a food according to the first embodiment), the ratio of the heat-treated vegetable in the food according to one or more embodiments of the present invention may be 80 mass % or more, particularly 90 mass % or more. If the ratio of the heat-treated vegetable is below the lower limit, vegetable flavor may not be sufficiently added, and the resultant taste may be unsatisfactory. On the other hand, there is no upper limit to the ratio of the heat-treated vegetable, which may be 100 mass % at maximum.

When the food according to one or more embodiments of the present invention is a food containing the heat-treated vegetable as one of a plurality of components (i.e., a food according to the second embodiment), the ratio of the heat-treated vegetable in the food according to one or more embodiments of the present invention is not limited, and may vary depending on, e.g., the type of the food. For example, the ratio of the heat-treated vegetable in the food according to one or more embodiments of the present invention may be 1.5 mass % or more, particularly 2.5 mass % or more. If the ratio of the heat-treated vegetable is below the lower limit, vegetable flavor may not be sufficiently added, and the resultant taste may be unsatisfactory. On the other hand, the ratio of the heat-treated vegetable in the food according to one or more embodiments of the present invention may be 20 mass % or less, particularly 15 mass % or less. If the ratio of the heat-treated vegetable exceeds the upper limit, the heated smell of the vegetable may be so strong that the unpleasant taste may be emphasized.

### [Process of Producing the Food Containing Heat-Treated Vegetable]

A second aspect according to one or more embodiments of the present invention relates to a process of producing the food containing heat-treated vegetable according to one or more embodiments of the present invention (hereinafter also referred to as “the process according to one or more embodiments of the present invention”).

The process according to one or more embodiments of the present invention includes subjecting vegetable to heat treatment to thereby prepare heat-treated vegetable. In one or more embodiments, the heat treatment of vegetable may be carried out by any conventional method, but may preferably include steps (1) and (2) below, since these steps would facilitate adjusting the contents of the specific ingredients to a preferred balance.

In step (1), vegetable is heated at a predetermined heating temperature with stirring, until the mass of the vegetable falls below a predetermined ratio or less with respect to the mass of the vegetable before the heating. Heating “at a predetermined heating temperature” herein means that heating is continued under conditions that the center temperature of the vegetable being heated stays in the range of the “predetermined heating temperature”, for example, for a period of time indicated below. In this regard, even if the temperature of the vegetable goes temporarily outside of the “predetermined heating temperature” range during heating, it is deemed that the heat treatment is substantially continued in the “predetermined heating temperature” range as long as such a deviation occurred only for, e.g., several minutes (e.g., within 5 minutes, preferably within 3 minutes).

In step (2), the vegetable heated in step (1) is then mixed with oil in an amount corresponding to a predetermined ratio with respect to the mass of the vegetable before the heating, and the mixture is further heated with stirring at a predetermined temperature.

The process according to one or more embodiments of the present invention may also include additional steps as necessary, such as the step of adjusting each of the contents of 3,4-dimethylthiophene, 2,4-dimethylthiophene, and furfural (specific ingredients) to within a predetermined concentration range, and/or the step of adding/mixing one or more other materials or ingredients which may optionally be used.

### *Step (1):

The “predetermined heating temperature” of the vegetable in step (1) may be, although not limited to, within a range of 70° C. or higher, particularly 80° C. or higher, and 120° C. or lower, particularly 110° C. or lower.

In one or more embodiments, the vegetable may preferably be heated at the “predetermined heating temperature” in step (1) for a period of, although not limited to, e.g., 30 minutes or longer, particularly 40 minutes or longer, and 120 minutes or shorter, particularly 110 minutes or shorter. The vegetable may also preferably be heated until the mass of the vegetable becomes 30 mass % or more, particularly 35 mass % or more, and 70 mass % or less, particularly 65 mass % or less, with respect to the mass of the vegetable before the heating.

In one or more embodiments, in order to promote the volatilization of aromatic ingredients from the vegetables, the heating in step (1) may preferably be carried out under reduced pressure and/or ventilated conditions.

In one or more embodiments, in order to promote the volatilization of moisture from the vegetable in step (1), a predetermined amount of sodium chloride may preferably be added to the vegetable before and/or during step (1). The amount of sodium chloride to be added may be, but not limited to, 1 mass % or more, particularly 1.5 mass % or more, and 10 mass % or less, particularly 7 mass % or less, with respect to the mass of the vegetable before the heating.

According to one or more embodiments of the present invention, sodium chloride may be added either in the form of a purified product or in the form of a mixture containing sodium chloride such as edible salt. When a mixture of sodium chloride with large amounts of impurities (e.g., rock salt) is used, the amount of the mixture to be added may preferably be adjusted in consideration of the content of sodium chloride.

### * Step (2):

In one or more embodiments, the amount of oil to be added in step (2) may preferably be, but not limited to, 1 mass % or more, particularly 2.5 mass % or more, and 10 mass % or less, particularly 7.5 mass % or less, with respect to the mass of the vegetable before the heating.

According to one or more embodiments of the present invention, examples of oil to be added include, although not limited to: sesame oil, rapeseed oil, soybean oil, palm fractionation oil (PMF), cottonseed oil, corn oil, sunflower oil, safflower oil, olive oil, linseed (amani) oil, rice oil, Japanese camellia (tsubaki) oil, Korean perilla (egoma) oil, grape seed oil, peanut oil, almond oil, avocado oil, salad oil, and canola oil.

The “predetermined heating temperature” of the vegetable in step (2) may be, although not limited to, 70° C. or higher, particularly 80° C. or higher, and 120° C. or lower, particularly 110° C. or lower.

In one or more embodiments, the vegetable may preferably be heated at the “predetermined heating temperature” in step (2) for a period of, although not limited to, e.g., 9 minutes or longer, particularly 12 minutes or longer, and 50 minutes or shorter, particularly 40 minutes or shorter. When the contents of the specific ingredients (3,4-dimethylthiophene, 2,4-dimethylthiophene, and furfural) are not adjusted via addition of these ingredients externally but are adjusted via heating of the vegetable (i.e., in the case of the first method mentioned later), the vegetable may also preferably be heated in this step at least until each content of the specific ingredients (3,4-dimethylthiophene, 2,4-dimethylthiophene, and furfural) of the heat-treated vegetable satisfies the predetermined concentration range.

There is no particular limitation to the apparatus for the heat treatment of the vegetable, as long as it can be heated at a constant temperature with stirring so that steps (1) and (2) above can be performed. In one or more embodiments, the apparatus may more preferably accommodate a device for promoting volatilization of heated steam via ventilation and/or reduced pressure. However, in order to carry out large-scale production of the heat-treated vegetable, it may be preferred to use a cylindrical process tank capable of controlling the heating temperature and stirring speed, from the viewpoint of productivity. An example of such a process tank is Leonida KH by Kajiwara Co., Ltd.

### *Adjustment of the Specific Ingredient Contents:

Methods for adjusting each content of 3,4-dimethylthiophene, 2,4-dimethylthiophene, and furfural (specific ingredients) in the food according to one or more embodiments of the present invention to within the specific concentration range include: the method of adjusting the content of each specific ingredient by carrying out steps (1) and (2) above to heat the vegetable (first method); and the method of adding these specific ingredients (or substances containing these specific ingredients) to the vegetable before, during, or after the heating (second method). In the case of the first method, for example, the contents of the specific ingredients can be easily adjusted to a suitable balance by carrying out steps (1) and (2) under the preferred conditions. In the case of the second method, these specific ingredients (or substances containing these specific ingredients) may be added to the vegetable before or during the heating in steps (1) and/or (2) and heated together with the vegetable. Alternatively, they may be added to, and mixed with, the heat-treated vegetable after completion of the heating in steps (1) and/or (2).

### *Addition and Mixing of Other Materials and Ingredients:

If the food according to one or more embodiments of the present invention contains other materials or ingredients that are optionally used in addition to the heat-treated vegetable, such other materials or ingredients may be added to, and mixed with, the vegetables. In this case, such other materials or ingredients may be added to the vegetable before or during the heating in steps (1) and/or (2) and heated together with the vegetable. Alternatively, they may be added to, and mixed with, the heat-treated vegetable after completion of the heating in steps (1) and/or (2). On the other hand, if the food according to one or more embodiments of the present invention does not contain any materials or ingredients other than the heat-treated vegetable, such a step is unnecessary.

### [Method for Reducing Unpleasant Taste of Vegetable]

A third aspect according to one or more embodiments of the present invention relates to a method for reducing unpleasant taste of vegetable. This method includes carrying out heat treatment of the vegetable in accordance with the process according to one or more embodiments of the present invention to thereby prepare the food containing heat-treated vegetable according to one or more embodiments of the present invention. Details of the method are the same as those explained above for the food containing heat-treated vegetable according to one or more embodiments of the present invention and the process of producing the same.

### EXAMPLES

One or more embodiments of the present invention will then be explained in further details by reference to the examples below, which are presented for the purpose of illustration only and should in no way be construed as limiting the present invention.

### [Preparation of Food Samples]

Food samples of Examples a1 to a10 and Comparative Examples b1 to b8 were prepared as shown in Table 1 below.

TABLE 1

| | | specific ingredient | | | | |
|---|---|---|---|---|---|---|
| | | Any | Base | 3,4- | 2,4- | |
| | | ingredient | food for | dimethylthiophene | dimethylthiophene | furfural |
| | | added? | addition | mg/kg | mg/kg | mg/kg |
| Example | a1 | No | | | | |
| Example | a2 | No | | | | |
| Example | a3 | Yes | Example a1 | 1.83 | 1.58 | — |
| Example | a4 | Yes | Example a1 | 2.63 | 2.08 | 0.51 |
| Example | a5 | Yes | Example a2 | — | — | 0.17 |
| Example | a6 | Yes | Example a2 | — | — | 9.17 |
| Example | a7 | No | | | | |
| Example | a8 | No | | | | |
| Example | a9 | No | | | | |
| Example | a10 | No | | | | |
| Comparative | b1 | No | | | | |
| Example | | | | | | |
| Comparative | b2 | Yes | Example b1 | 4.07 | 4.87 | — |
| Example | | | | | | |
| Comparative | b3 | Yes | Example a1 | — | 4.08 | 0.51 |
| Example | | | | | | |
| Comparative | b4 | Yes | Example a1 | 4.63 | — | 0.51 |
| Example | | | | | | |
| Comparative | b5 | Yes | b1 | — | — | 14.91 |
| Example | | | | | | |
| Comparative | b6 | No | | | | |
| Example | | | | | | |
| Comparative | b7 | Yes | b6 | 2.00 | — | — |
| Example | | | | | | |
| Comparative | b8 | Yes | b6 | — | 2.00 | — |
| Example | | | | | | |

The samples of Examples and Comparative Examples without addition of any specific ingredients were prepared as follows.

### Preparation of Examples a1 and a2

1. 50 kg of frozen onion (frozen after being cut into 10 mm squares) and 2 kg of sodium chloride were put into a process tank (PC-5150, φ594 mm, Soren).
2. The mixture was then heated under the conditions shown below. During heating, the lid was closed while ventilation was performed for actively promoting the volatilization of aromatic ingredients from the vegetable.

Product temperature: 100° C.

Stirring speed: 30 rpm

The above conditions were continued for 60 minutes until the mass reached 25 kg.

At this stage, a part of the sample was collected and used as the sample of Example a1.

3. When the vegetable mass reached 25 kg (the amount of salt was subtracted), 3 kg of oil (olive oil) was added.
4. The mixture was then heated under the conditions shown below. During heating, no ventilation was performed, while the aroma ingredients were volatilized by opening the lid.

Temperature: 100° C.

Stirring speed: 30 rpm

The above conditions were continued for 20 minutes until the mass reached 20 kg.

5. When the vegetable mass reached 20 kg (as corrected by subtracting the amounts of oil and salt), heating was stopped, and 20 kg of water was added. Stirring was continued during this operation. A part of this sample was taken and used as the sample of Example a2.

### Preparation of Comparative Example b1

The frozen onion (frozen after being cut into 10 mm squares) used for preparing the samples of Examples a1 and a2 was used as the sample of Comparative Example b1.

### Preparation of Comparative Example b6

1. Tomato sauce was prepared by mixing 62 mass % of tomato paste (Brix value: 15), 1.0 mass % of sodium chloride, 1.6 mass % of soybean oil, and the remainder of water with stirring.
2. 500 g of the above mixture was heated (set temperature: 95° C.; kept at the temperature for 5 minutes) with stirring, and the resultant tomato sauce was filled in a pouch as the sample of Comparative Example b6.

### Preparation of Examples a7 to a10

1. Tomato sauce was prepared by mixing 62 mass % of tomato paste (Brix value: 15), salt 1.0 mass %, and soybean oil 1.6 mass %, and a predetermined amount of the sample of Example a1 (1.5 mass % for Example a7, 2.5 mass % for Example a8, 10 mass % for Example a9, and 20 mass % for Example a10), to which water was added as the balance, followed by stirring and mixing.
2. 500 g of the above mixture was heated (set temperature: 95° C.; kept at the temperature for 5 minutes) with stirring, and the resultant tomato sauce was filled in a pouch as the sample of each of Examples a7 to a10.

### *Addition of Specific Ingredients:

The samples of Examples and Comparative Examples with addition of any specific ingredients were prepared by using the following substances as the specific ingredients, each diluted to a high concentration with ethanol, and adding the diluted specific ingredient to the sample of the corresponding Example or Comparative Example with addition of any specific ingredients, so that the resultant concentration of each specific ingredient reaches the value shown in Table 1 above.

3,4-Dimethylthiophene (Thiophene,3,4-dimethyl-: CAS No.632-15-5; Combi-Blocks, Inc.)
2,4-Dimethylthiophene (Thiophene,2,4-dimethyl-: CAS No.638-00-6; Fuji Film Wako Chemical Corp.)

### Furfural (Furfural: CAS No.98-01-1; Tokyo Chemical Industry Co., Ltd.)

[Measurement of Specific Ingredients]

The contents of 3,4-dimethylthiophene, 2,4-dimethylthiophene, and furfural as specific ingredients were measured using a gas chromatography/mass spectrometer (GC/MS) by the following method.

First, each sample of the Examples and the Comparative Examples were subjected to Pretreatments 1 to 6 below to prepare a measurement sample.

1. From each sample of the Examples and the Comparative Examples, 10 g was collected as a measurement sample. However, when the sample consists only of heat-treated vegetable, ion-exchanged water was added so as to correspond to the mass of the vegetable before heating. (For example, when heat-treated vegetable with a concentration rate of 50% was used as the measurement sample, 5 g of water was added to 5 g of the sample and the mixture was used as the measurement sample.)
2. Ion exchanged water was added to the measurement sample from Pretreatment 1 to adjust the total mass to 100 g.
3. After the dilution of Pretreatment 2, the measurement sample was filtered with a filter paper (No. 2), and the filtrate was put into a 20 mL headspace vial (flat bottom).
4. PDMS Twister (film thickness 0.5 mm, length 10 mm) (GERSTEL) was placed in the vial from Pretreatment 3, and shaken for 60 minutes to adsorb the ingredients.
5. After 60 minutes, the filtrate was removed from the vial of Pretreatment 4, and PDMS Twister was rinsed with ion-exchanged water.
6. After the rinsing of Pretreatment 5, the moisture was wiped off with a Kimwipe, and the sample in the PDMS Twister was used as a measurement sample.

### *Measurement Method:

The measurement sample prepared above was subjected to measurement of the specific ingredients using Gestell 1-dimensional 2-dimensional switching GC-MS (GC part: HP7890 Series GC System connected to LTM series II (both manufactured by Agilent), inlet: TDU2/CIS4 (Gestel), autosampler: MPS (Gestel)).

As capillary columns, DB-WAX (length 30 m, inner diameter 250 μm, film thickness 0.25 μm, for LTM) (Agilent) was used as a one-dimensional column, and DB-5 (length 10 m, inner diameter 180 μm, film thickness 0.4 μm, for LTM) (Agilent) was used as a two-dimensional column. Helium was used as the carrier gas.

Of the specific ingredients, furfural was measured by one-dimensional analysis, while 3,4-dimethylthiophene and 2,4-dimethylthiophene were measured by two-dimensional analysis. The injection was performed using one PDMS twister that had been subjected to the above pretreatment, and the injection conditions were all as follows.

### *CIS4:

Maintained at 10° C. for 0.5 minutes, then heated up to 240° C. at 720° C./minute.

### *TDU2:

Maintained at 30° C. for 0.2 minutes, then heated up to 240° C. at 720° C./minute.

For the measurement of 3,4-dimethylthiophene and 2,4-dimethylthiophene, the sample was injected into a one-dimensional column under the above injection conditions, backflushing was performed during a period between at 12 minutes and at 16 minutes from the start of measurement, and the specific ingredients were introduced into a two-dimensional column for separation, and subjected to SIM analysis. The column oven conditions for DB-WAX (one-dimensional column) and DB-5 (two-dimensional column) were as follows.

### *DB-WAX (One-Dimensional Column):

Maintained at 40° C. for 3 minutes, then heated at 5° C./minute, and then cut off at 41.5 minutes from the start of measurement.

### *DB-5 (Two-Dimensional Column):

Maintained at 40° C. for 16.5 minutes, then heated to 240° C. at 20° C./minute, and then maintained for 15 minutes.

For the measurement of furfural, the sample was injected under the above injection conditions, separated with a one-dimensional column, and subjected to SIM analysis. The column oven conditions for DB-WAX (one-dimensional column) were as follows.

### *DB-WAX (One-Dimensional Column):

Maintained at 40° C. for 3 minutes, then heated to 240° C. at 5° C./minute, and then maintained for 7 minutes.

The concentration of each specific ingredient in each measurement sample was calculated from the area of the quantitative ion of the corresponding standard substance shown in Table 2 below, which was measured in the selected ion detection (SIM) mode, and was corrected in consideration of the dilution ratio with water.

TABLE 2

| | Quantitation | Confirmation | Confirmation |
|---|---|---|---|
| | ion | ion 1 | ion 2 |
| 3,4-Dimethylthiophene | 111 | 97 | 112 |
| 2,4-Dimethylthiophene | 111 | 97 | 112 |
| Furfural | 95 | 96 | 67 |

Peaks with a ratio of peak signal to base noise (S/N ratio) of less than 10 were determined as not-detectable (ND), since noise was so large that quantification was difficult.

The measurement results of the contents of 3,4-dimethylthiophene, 2,4-dimethylthiophene, and furfural in each sample of the Examples and Comparative Examples are shown in Table 3 below.

TABLE 3

| | | 3,4- | 2,4- | | |
|---|---|---|---|---|---|
| | | Dimethyl- | Dimethyl- | | |
| | | thiophene | thiophene | Furfural | |
| | | (x) | (y) | (z) | |
| | | mg/kg | mg/kg | mg/kg | (x + y)/z |
| Example | a1 | 0.3690 | 0.92436 | 0.4922 | 2.6276 |
| Example | a2 | 0.0038 | 0.00955 | 0.8270 | 0.0162 |
| Example | a3 | 2.2000 | 2.50000 | 0.4922 | 9.5483 |
| Example | a4 | 3.0000 | 3.00000 | 1.0000 | 6.0000 |
| Example | a5 | 0.0038 | 0.00955 | 1.0000 | 0.0134 |
| Example | a6 | 0.0038 | 0.00955 | 10.0000 | 0.0013 |
| Example | a7 | 0.0004 | 0.00019 | 0.3144 | 0.0017 |
| Example | a8 | 0.0004 | 0.00028 | 0.3196 | 0.0021 |
| Example | a9 | 0.0007 | 0.00099 | 0.3586 | 0.0046 |
| Example | a10 | 0.0010 | 0.00195 | 0.4107 | 0.0072 |
| Comparative | b1 | 0.9345 | 0.13187 | 0.0855 | 12.468 |
| Example | | | | | |
| Comparative | b2 | 5.0000 | 5.00000 | 0.0855 | 116.924 |
| Example | | | | | |
| Comparative | b3 | 0.3690 | 5.00000 | 1.0000 | 5.369 |
| Example | | | | | |
| Comparative | b4 | 5.0000 | 0.92436 | 1.0000 | 5.924 |
| Example | | | | | |
| Comparative | b5 | 0.9345 | 0.13187 | 15.0000 | 0.0711 |
| Example | | | | | |
| Comparative | b6 | 0.0003 | 0.00004 | 0.3066 | 0.0011 |
| Example | | | | | |
| Comparative | b7 | 0.0003 | 2.00000 | 0.3066 | 6.5247 |
| Example | | | | | |
| Comparative | b8 | 2.00000 | 0.00004 | 0.3066 | 6.5238 |
| Example | | | | | |

### [Content of Heat-Treated Vegetable]

The content of the heat-treated vegetable in each sample was determined by weighing the mass of the heat-treated vegetable using a weigh scale (load cell LC-1205 (A & D) for large capacity, precision scale HT-120 (A & D) for small capacity), and calculating the mass ratio with respect to the other materials in the sample.

The measurement results of the heat-treated vegetable content in each sample of the Examples and the Comparative Examples are shown in Table 4 below.

TABLE 4

| | | Content of |
|---|---|---|
| | | heat-treated vegetable |
| | | Weight % |
| Example | a1 | 100 |
| Example | a2 | 100 |
| Example | a3 | 100 |
| Example | a4 | 100 |
| Example | a5 | 100 |
| Example | a6 | 100 |
| Example | a7 | 1.5 |
| Example | a8 | 2.5 |
| Example | a9 | 10 |
| Example | a10 | 20 |
| Comparative Example | b1 | 0 |
| Comparative Example | b2 | 0 |
| Comparative Example | b3 | 100 |
| Comparative Example | b4 | 100 |
| Comparative Example | b5 | 0 |
| Comparative Example | b6 | 100 |
| Comparative Example | b7 | 100 |
| Comparative Example | b8 | 100 |

### [Sensory Evaluation]

Each sample was evaluated under the following conditions. Each evaluation was conducted by six sensory inspectors who conducted the following trainings.

Candidates were subjected to the identification trainings A) and B) below, and those with particularly excellent results were selected as sensory inspectors.

A) Test for distinguishing taste qualities: candidates were tested as to whether they could distinguish test samples for five taste qualities (sweetness: the taste of sugar; sourness: the taste of tartaric acid; umami: the taste of sodium glutamate; saltiness: the taste of sodium chloride; and bitterness: the taste of caffeine) and two control samples. Each test sample was an aqueous solution of the corresponding standard substance at a concentration slightly higher than its threshold, while each control sample was distilled water.
B) Test for distinguishing taste strength: candidates were tested as to whether they could distinguish five aqueous solutions of sodium chloride at different concentrations and five aqueous solutions of acetic acid at different concentrations.
Each sample was evaluated for the following two evaluation items:

### *Unpleasant Taste of Vegetable:

5: Excellent, as the unpleasant taste was not scented at all.
4: Good, as the unpleasant taste was scarcely scented.
3: Acceptable, as the unpleasant taste was scented.
2: Not very good, as the unpleasant taste was somewhat scented.
1: Not good, as the unpleasant taste was strongly scented.

### *Cooked Feel of Vegetable

5: Excellent, as the cooked feel was strongly scented.
4: Good, as the cooked feel was somewhat scented.
3: Acceptable, as the cooked feel was scented.
2: Not very good, as the cooked feel was scarcely scented.
1: Not good, as the cooked feel was not scented at all.

The results of the sensory evaluations are shown in Table 5 below. Each score in the table is a value obtained by calculating the average score of the six sensory inspectors and rounding off to the first decimal place. The samples of the Examples were satisfactory with scores of 3 or higher for both the unpleasant taste of vegetable and the cooked feel of vegetable, while the samples of the Comparative Examples were unsatisfactory with scores of 2 or lower for both evaluation items.

TABLE 5

| | | Unpleasant taste | Cooked feel |
|---|---|---|---|
| | | of vegetable | of vegetable |
| Example | a1 | 4 | 4 |
| Example | a2 | 5 | 5 |
| Example | a3 | 3 | 3 |
| Example | a4 | 3 | 3 |
| Example | a5 | 4 | 4 |
| Example | a6 | 3 | 3 |
| Example | a7 | 3 | 3 |
| Example | a8 | 4 | 4 |
| Example | a9 | 3 | 3 |
| Example | a10 | 3 | 3 |
| Comparative Example | b1 | 1 | 2 |
| Comparative Example | b2 | 1 | 1 |
| Comparative Example | b3 | 1 | 2 |
| Comparative Example | b4 | 1 | 2 |
| Comparative Example | b5 | 2 | 1 |
| Comparative Example | b6 | 1 | 1 |
| Comparative Example | b7 | 1 | 1 |
| Comparative Example | b8 | 1 | 1 |

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A food product comprising a heat-treated vegetable,
wherein a content of 3,4-dimethylthiophene (x) in the food product ranges from 0.00035 mg/kg to 3 mg/kg,
wherein a content of 2,4-dimethylthiophene (y) in the food product ranges from 0.00015 mg/kg to 3 mg/kg, and
wherein a content of furfural (z) in the food product ranges from 0.1 mg/kg to 10 mg/kg.

2. The food product according to claim 1, wherein the food product satisfies the following formula:
10≥(x+y)/z≥0.0005

3. The food product according to claim 1, wherein the heat-treated vegetable is Allium.

4. The food product according to claim 3, wherein the Allium is one or more selected from onion, Welsh onion (negi), leek, and garlic.

5. The food product according to claim 1, wherein the food product comprises 1.5 mass % or more of the heat-treated vegetable.

6. A process for producing the food product according to claim 1, comprising:
heating vegetable with stirring at a temperature ranging from 70° C. to 120° C., until a weight of the vegetable after the heating is reduced to an amount ranging from 30 mass % to 70 mass % of a weight of the vegetable before the heating; and
adding oil to the heated vegetable in an amount ranging from 1 mass % to 10 mass % with respect to the weight of the vegetable before the heating; and
further heating the heated vegetable and the oil with stirring at a temperature ranging from 70° C. to 120° C.

7. The process according to claim 6, wherein a depressurization treatment and/or a ventilation treatment is performed during the heating that is performed prior to adding the oil.

8. The process according to claim 6, further comprising, before or during the heating that is performed prior to adding the oil, adding sodium chloride to the vegetable in an amount ranging from 1 mass % to 10 mass % with respect to the weight of the vegetable before the heating.

9. The process according to claim 6, wherein heating the heated vegetable and the oil is carried out until the resultant food product comprising the heat-treated vegetable comprises:
0.00035 mg/kg to 3 mg/kg of 3,4-dimethylthiophene (x);
0.00015 mg/kg to 3 mg/kg of 2,4-dimethylthiophene (y); and
0.1 mg/kg to 10 mg/kg of furfural (z).

10. The process according to claim 6, further comprising adding one or more selected from the group consisting of 3,4-dimethylthiophene, 2,4-dimethylthiophene, and furfural to at least one of the vegetable prior to the heating, the heated vegetable, or the heated vegetable and the oil.

11. A method for reducing unpleasant taste of a vegetable, comprising:
adjusting contents of a food product containing a heat-treated vegetable, wherein the food product comprises:
0.00035 mg/kg to 3 mg/kg of 3,4-dimethylthiophene (x);
0.00015 mg/kg to 3 mg/kg of 2,4-dimethylthiophene (y); and
0.1 mg/kg to 10 mg/kg of furfural (z).

12. The food product produced by the process according to claim 6,
wherein the food product comprises the heat-treated vegetable and the oil,
wherein a content of 3,4-dimethylthiophene (x) in the food product ranges from 0.00035 mg/kg to 3 mg/kg,
wherein a content of 2,4-dimethylthiophene (y) in the food product ranges from 0.00015 mg/kg to 3 mg/kg, and
wherein a content of furfural (z) in the food product ranges from 0.1 mg/kg to 10 mg/kg.
